(19) United States
(12) Patent Application Publication
(10) Pub. No.: US 2016/0140626 A1
(43) Pub. Date: May 19, 2016

(54) WEB PAGE ADVERTISEMENT CONFIGURATION AND OPTIMIZATION WITH VISUAL EDITOR AND AUTOMATIC WEBSITE AND WEBPAGE ANALYSIS

(71) Applicants: ATUL AGARWAL, NEW DEHLI (IN); DHIRAJ SINGH, NEW DEHLI (IN)

(72) Inventors: ATUL AGARWAL, NEW DEHLI (IN); DHIRAJ SINGH, NEW DEHLI (IN)

(21) Appl. No.: 14/881,042

(22) Filed: Oct. 12, 2015

Related U.S. Application Data
(60) Provisional application No. 62/062,943, filed on Oct. 12, 2014.

(51) Int. Cl. G06Q 30/02; G06F 17/24; G06F 17/22

(52) U.S. Cl. CPC G06Q 30/0276; G06F 17/2247; G06F 17/24

(57) ABSTRACT

In one aspect, a computerized-method implemented by at least one server include the step of providing a web-page document visual editor. The method includes the step of providing a web-page and website analysis engine, which does automated webpage and website analysis. The method includes the step of placing, with the web-page document visual editor and the automatic analysis engine, an advertisement selector in a web page document. The method includes the step of identifying one or more advertisement attributes of the web-page document. The method includes the step of setting a location of an advertisement block in a display of the web-page document with respect to an element of the web page document. The method includes the step of generating a global tag, wherein the global tag comprises a system instrumentation JavaScript code, and wherein the global tag retrieves a list of relevant selectors. The method includes the step of inserting the global tag into the web-page document.

### BRIEF DESCRIPTION OF THE DRAWINGS

FIG. 1 illustrates an example process for advertisement placement within a web page document, according to some embodiments.

FIG. 2 illustrates an example process displaying a web page with a global tag, according to some embodiments.

FIG. 3 depicts, in block diagram format, a system for placement of advertisements within a web page document, according to some embodiments.

FIG. 4 depicts an exemplary computing system that can be configured to perform any one of the processes provided herein.

FIG. 5 illustrates another block diagram of a sample computing environment with which embodiments may interact.

FIGS. 6-8 depicts various screen shots of use cases of an example embodiment.

FIGS. 9 A-B provide a method of implementing automatic advertisement placement using visual analysis of web pages, according to some embodiments.

FIGS. 10 A-B depict examples of using contiguous area detection for automatic advertisement placement on a webpage, according to some embodiments.

FIG. 11 illustrates an example process of using Webpage DOM analysis, according to some embodiments.

The Figures described above are a representative set, and are not an exhaustive with respect to embodying the invention.

### DESCRIPTION

Disclosed are a system, method, and article of manufacture of advertisement placement with a webpage documents using fuzzy selectors. The following description is presented to enable a person of ordinary skill in the art to make and use the various embodiments. Descriptions of specific devices, techniques, and applications are provided only as examples. Various modifications to the examples described herein can be readily apparent to those of ordinary skill in the art, and the general principles defined herein may be applied to other examples and applications without departing from the spirit and scope of the various embodiments.

Reference throughout this specification to “one embodiment,” “an embodiment,” ‘one example,’ or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art can recognize, however, that the invention may be practiced without one or more of the specific details, or with other methods, components, materials, and so forth. In other instances, well-known structures, materials, or operations are not shown or described in detail to avoid obscuring aspects of the invention.

The schematic flow chart diagrams included herein are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, and they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

### DEFINITIONS

Advertisement unit can be an advertisement or set of advertisements displayed as a result of a piece of advertisement code being executed.

Back-end database can be a database that is accessed by users indirectly through an external application rather than by application programming stored within the database itself or by low level manipulation of the data (e.g. through SQL commands).

A digital wallet can be an electronic device that allows the user to make electronic commerce transactions. This can include purchasing items on-line with a computer.

Element of interest can be a web-page element near which an advertisement can be placed.

Global tag can be a common snippet of code that needs to be inserted once in every page. This snippet might have configurable parameters.

Fuzzy selector represents a string which can refer to unique page elements, across pages, using wildcards and various standard (e.g. CSS selectors) non-standard (e.g. elements approximating a coordinate (e.g. x-y coordinate) location) attributes. Standard CSS selectors may be very specific, and they don't work well across multiple pages.

JSON (JavaScript Object Notation) can be a standard format that uses human-readable text to transmit data objects consisting of attribute-value pairs. As used herein, other similar formats can alternatively be used (e.g. Extensible Markup Language (XML)) in some example embodiments in lieu of JSON.

Uniform resource locator (URL) can be a specific character string that constitutes a reference to a resource. Most web browsers display the URL of a web page above the page in an address bar.

Visual editors (e.g. a full screen editor) can include an editing program(s) which displays the text/document being edited on the screen as it is being edited.

Web page is a web document that is suitable for the World Wide Web and display with a web browser. A web page document can include text, images, markup language elements (e.g. HTML, CSS, XHTML elements and/or commands), advertisement-related scripts (e.g. global tags) and the like.

XML Path Language (XPath) can be a query language (e.g. for selecting nodes from an XML document).

Exemplary Methods

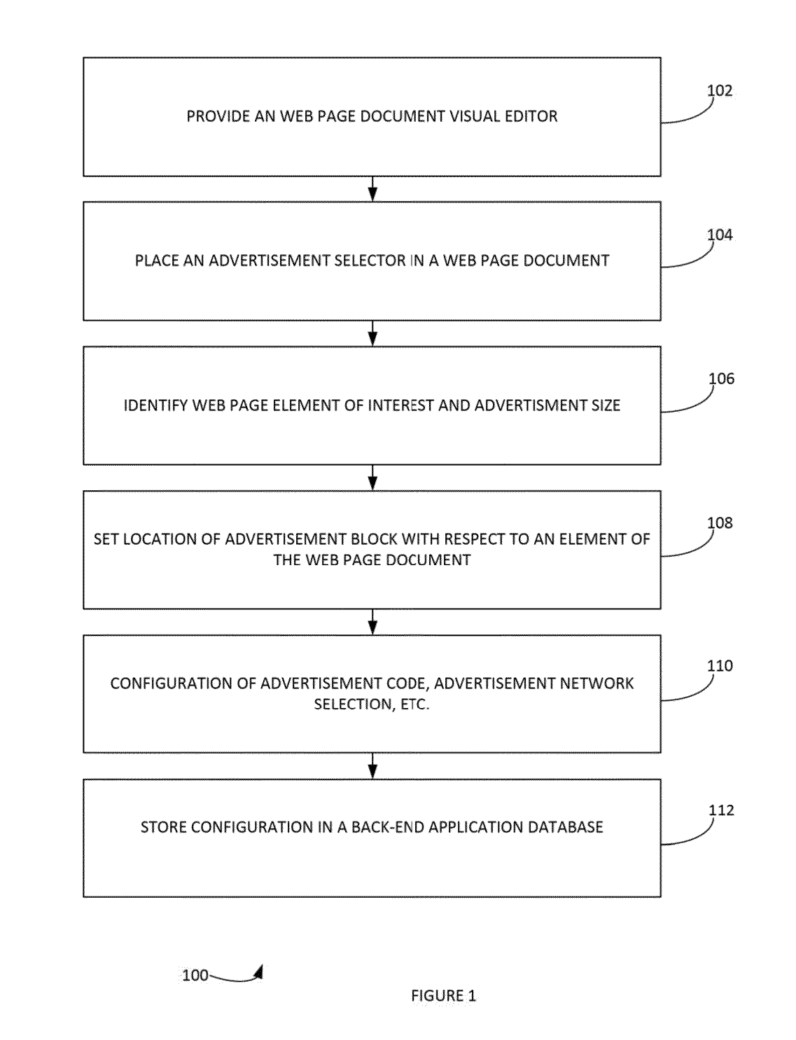

FIG. 1 illustrates an example process 100 for advertisement placement within a web page document, according to some embodiments. In step 102 of process 100, a web-page document visual editor can be provided. For example, the web-page document visual editor can be an application a user installs on a local and/or cloud-based computing system. The user can use the web-page document visual editor to place and/or configure web-page advertisement in a web-page document. Example use cases of an exemplary web-page document visual editor are provided in the screen shots infra.

In step 104, an advertisement selector is placed in the web page document. The web-page document visual editor can be used to generate said advertisement selector. In step 106, a web-page element of interest and/or advertisement size (and/or other advertisement attributes) can be identified. For example, the web-page document visual editor can included functionalities for implementing step 106. In step 108, the location of an advertisement block can be set with respect to an element of the web page document. For example, location vis-à-vis the web-page element can be set with one of four operations (e.g. append, prepend, insert before, insert after). These operations can be accessed via a drop-down menu and/or other visual editor interface. For example, an advertisement-sized block can be placed inside the webpage. This advertisement-sized block can be replaced with the actual advertisement (e.g. as configured by the user in step 110) when the web page is visited by a visiting user. It is noted that the advertisement-sized block can be placed at a desired location, without actually placing the advertisement code in line with the webpage code and/or content. In step 110, an advertisement code, advertisement network selection, etc. can be configured.

Process 100 can be repeated for a plurality of web page documents. For example, the visual editor can be used to insert a global tag (e.g. the script generated via process 100) on all of the web pages to display advertisement. As noted, various examples screen shots of the steps of process 100 are provided infra.

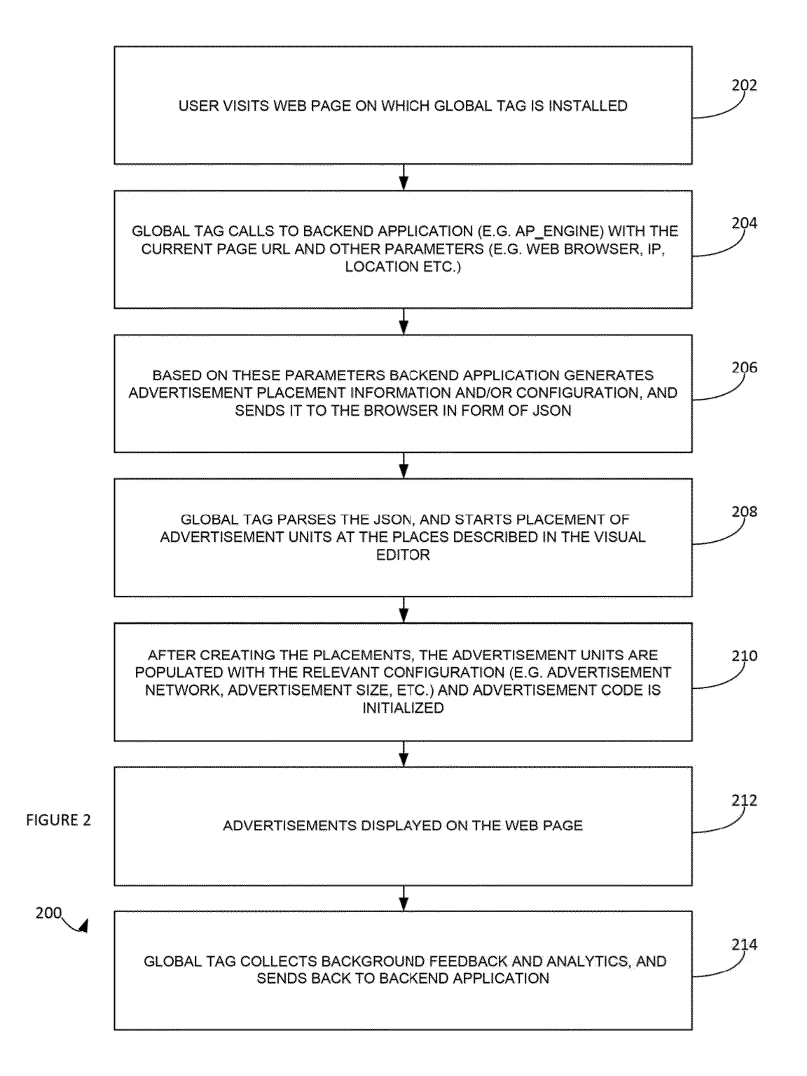

FIG. 2 illustrates an example process 200 displaying a web page with a global tag, according to some embodiments. In step 202 or process 200, a user visits web page on which global tag is installed. In step 204, global tag calls to backend application (e.g. an application engine) with the current page URL and other parameters (e.g. web browser, Internet protocol (IP) address, location, etc.). In step 206, based on these parameters backend application generates advertisement placement information and/or configuration, and sends it to the browser in form of JSON. In step 208, the global tag parses the JSON, and starts placement of advertisement units at the places described in the visual editor. In step 210, after creating the placements, the advertisement units are populated with the relevant configuration (e.g. advertisement network, advertisement size, etc.) and advertisement code is initialized. In step 212, the advertisement(s) can be displayed on the web page(s). In step 214, the global tag can collects background feedback and analytics, and sends back to backend application.

Advertisements can also be pushed up on multiple web-pages. For example, the processes provided for the single web page document (e.g. a single HTML page) can be repeated and/or otherwise modified to implement advertisement(s) on a plurality of web page documents. Accordingly, the advertisement(s) can be displayed website wide. For example, the processes can group similar structured web pages (e.g. web pages which have similar layout) and an advertisement setup on any one of web pages can be automatically implemented across the group.

Grouping process can be manual, automatic and/or a combination thereof, according to various embodiments. For example, WordPress® (a popular content management system (CMS)) can have multiple webpage templates (e.g. postTypes), based on which content is created. As these postTypes have similar page layouts, one page from each of these groups can be selected (postTypes) and an advertisement setup created. The group information can be passed on as a parameter on the global tag when placing in on a webpage document. One can also utilize URL patterns using regular expressions or wildcard, to group the pages. For example, “website.com/sports/*” pattern can mean that all pages which start with this “website.com/sports” will be grouped together. Another approach for grouping can be automatic analysis (DOM—document object model, visual) of the webpages which are reported by the AdPushup Global Tag™. If the URLs in question have “similar DOM structure”, and “visually” look the same, we can group them together automatically. “Similar DOM structure” means if the DOM of two webpages have certain threshold of common elements. Visual analysis would mean that the pages follow the same visual style. Both DOM and Visual analysis would happen using similar fashion as described in section “AUTOMATED ADVERTISEMENT PLACEMENT USING VISUAL ANALYSIS OF PAGES”, for example.

A Fuzzy selector can be based on standard (e.g. CSS/XPath Selector) and non-standard attributes (page X-Y, wildcards, etc.) can be implemented. In other words, an XPATH/CSS selector as an example (among others) of a fuzzy selector. When web pages are grouped into a web page, cases where a CSS/XPath selector is very specific to a particular web-page (e.g. isn't available on other web pages of the group). If a user creates an advertisement placement based on such a CSS/XPATH selector, the advertisement may fail on other pages on the group. The visual editor tool can identify selectors that are page specific and converts them to ‘fuzzy selectors’ using wildcards. These fuzzy selectors can be implemented across multiple pages in the group. This approach can be dictionary and/or heuristics based. For example, in some embodiments, in WordPress (a popular CMS), the content can sometimes be wrapped in a container with an identifier (ID) attribute such as “post-1234” (where “1234” represents internal content serial number). The system can be trained to automatically identify such components, and normalize these, so the selector works across all pages. The new fuzzy container in this instance can be something like “id:post-[0-9].*”, which represents that the selector can be anything which has an ID starting with “post-” and follows up with any combination of numbers from “0-9” (note that this is just an illustration—the actual fuzzy selector might evolve over time).

In one example, a confidence indicator can be provided for the selectors. Selectors that are unlikely to be repeated across multiple pages reliably can be marked as ‘low confidence’ (or, in some examples, eliminated altogether) so as not to be utilized in process 100.

Various fuzzy selector failure methods can be implemented. For example, even with the above measures in place, it can be detected that a selector has failed on a web page. Various steps can be taken when this is detected, including, inter alia:

1) Serve extra ‘advertisement units’ as fallback selectors. For example, if one selector fails, another can serve the advertisement on the fallback selector.

2) A reactive approach via blacklisting can also be implemented. For example, in the background feedback message that the global tag communicates to the back-end application (e.g. the AP_engine), the selector failures can be recorded for particular URLs. Based on an algorithm and thresholds, the likelihood of future failures for the particular selector on particular URL, group, and/or block can be calculated. These measurements can be used to prevent further failures. For example, the web-page publisher can be notified to create alternative placement of said selectors.

The algorithm/threshold can be decided based on various parameters. One of the implementations can be based on the ratio or percentage of successful requests to failures, measured incrementally with time. For instance, let's assume for selector X and URL Y (combination X-Y), it can be determined that historically (e.g. based on continual analysis of incoming feedback) in 95% of the cases, the combination works, but for the past few hours, this combination X-Y is producing success rates of 80% or so. This represents something has changed on the page, based on which trigger the fallback mechanisms (alert the site owner, automatically find out alternate selector etc.)

Exemplary Computer Architecture and Systems

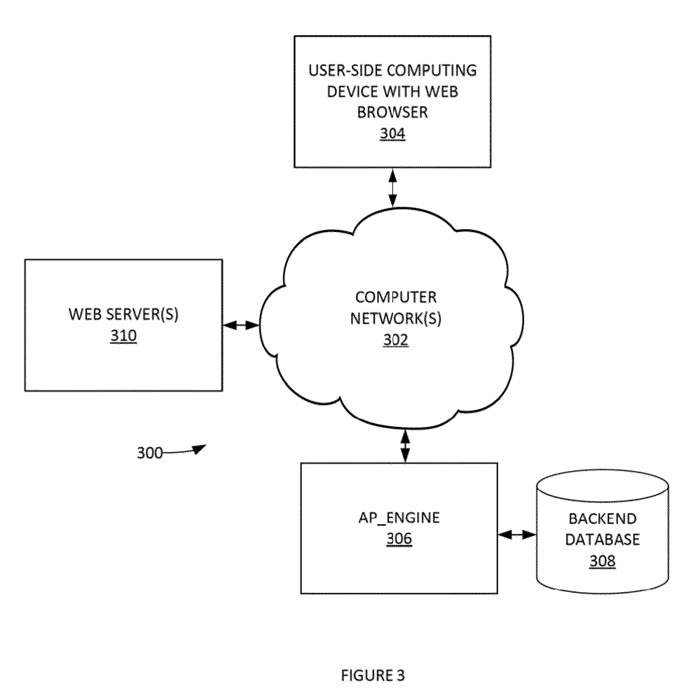

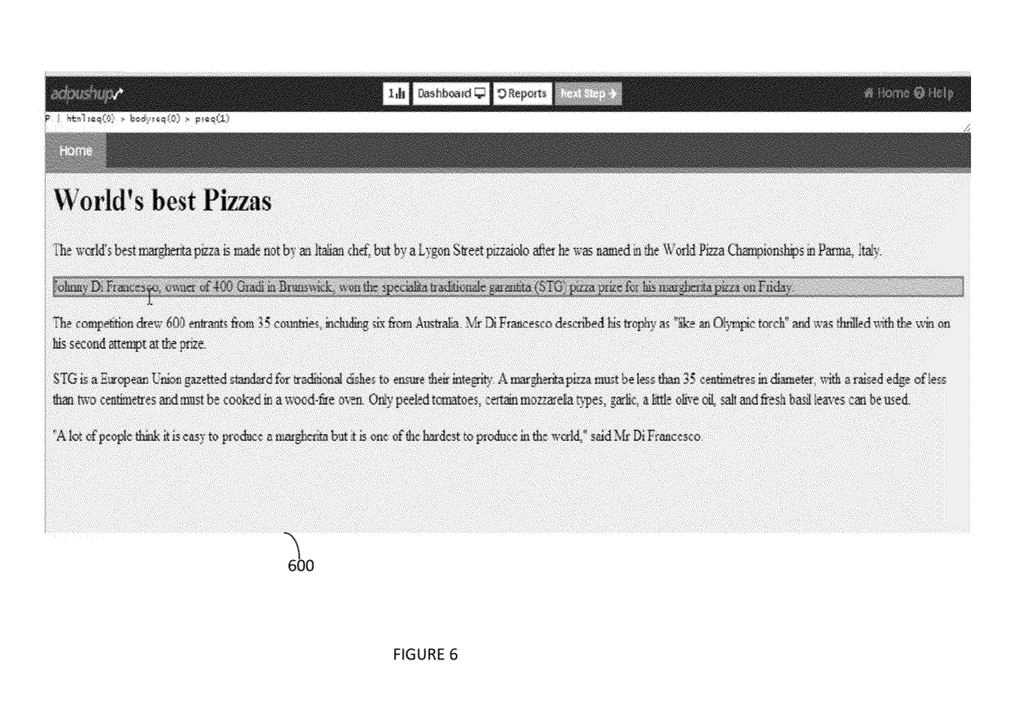

The systems of FIGS. 3-5 can be used to implement the systems, models and/or processes of FIGS. 1-2 and/or other methods provided herein, according to various embodiments. The systems of FIGS. 3-5 can be used to implement the use cases of FIGS. 6-8 as well.

FIG. 3 depicts, in block diagram format, a system 300 for placement of advertisements within a web page document, according to some embodiments. System 300 can include a user-side computing device with a web browser 304 that communicates with a web server(s) 310 and back-end application (e.g. the AP_engine 306). AP_engine 306 can implement CSS/XPATH selectors. AP_engine 306 can support said CSS/XPATH selectors (e.g. fuzzy selectors) across multiple webpages such web pages served by web server(s) 310. Information relevant to various CSS/XPATH selectors can be stored in backend database 308. System 300 can implement the various processes and methods provided herein. In some examples, system 300 can be implemented in a cloud-computing environment.

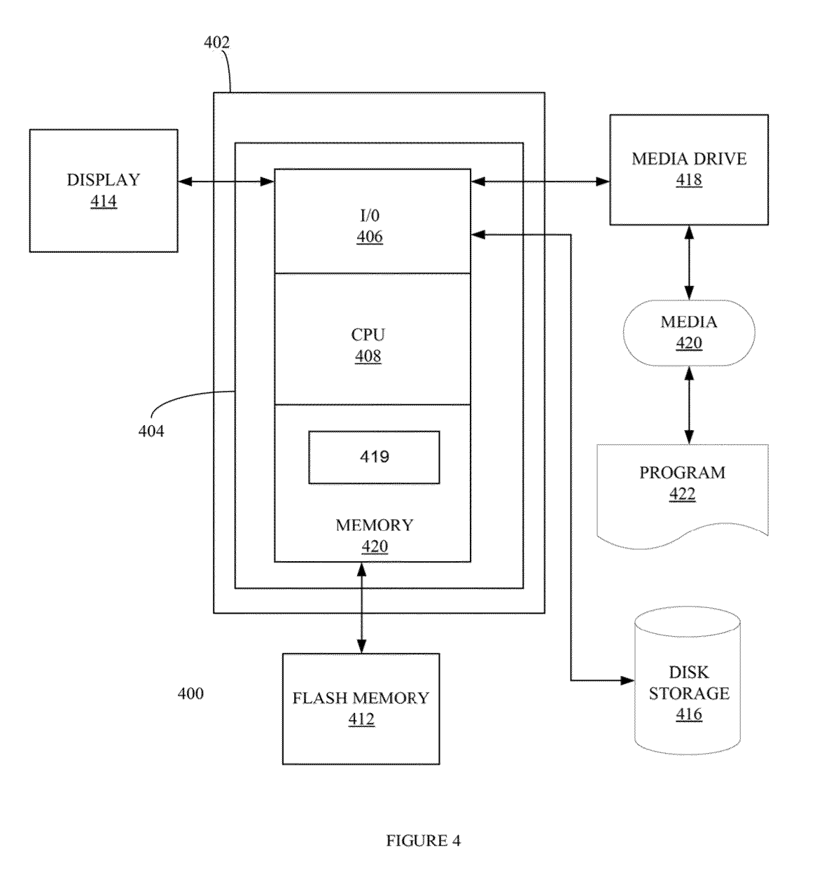

FIG. 4 depicts an exemplary computing system 400 that can be configured to perform any one of the processes provided herein. In this context, computing system 400 may include, for example, a processor, memory, storage, and I/O devices (e.g., monitor, keyboard, disk drive, Internet connection, etc.). However, computing system 400 may include circuitry or other specialized hardware for carrying out some or all aspects of the processes. In some operational settings, computing system 400 may be configured as a system that includes one or more units, each of which is configured to carry out some aspects of the processes either in software, hardware, or some combination thereof.

FIG. 4 depicts computing system 400 with a number of components that may be used to perform any of the processes described herein. The main system 402 includes a motherboard 404 having an I/O section 406, one or more central processing units (CPU) 408, and a memory section 410, which may have a flash memory card 412 related to it. The I/O section 406 can be connected to a display 414, a keyboard and/or other user input (not shown), a disk storage unit 416, and a media drive unit 418. The media drive unit 418 can read/write a computer-readable medium 420, which can contain programs 422 and/or data. Computing system 400 can include a web browser. Moreover, it is noted that computing system 400 can be configured to include additional systems in order to fulfill various functionalities. Computing system 400 can communicate with other computing devices based on various computer communication protocols such a Wi-Fi, Bluetooth® (and/or other standards for exchanging data over short distances includes those using short-wavelength radio transmissions), USB, Ethernet, cellular, an ultrasonic local area communication protocol, etc. In one example, computing system 400 can be a mobile device and include a module 419 that includes a credit/debit card mode application. In another example, computing system 400 can be a server system and include a module 419 that includes a back-end application (e.g. an AP_engine).

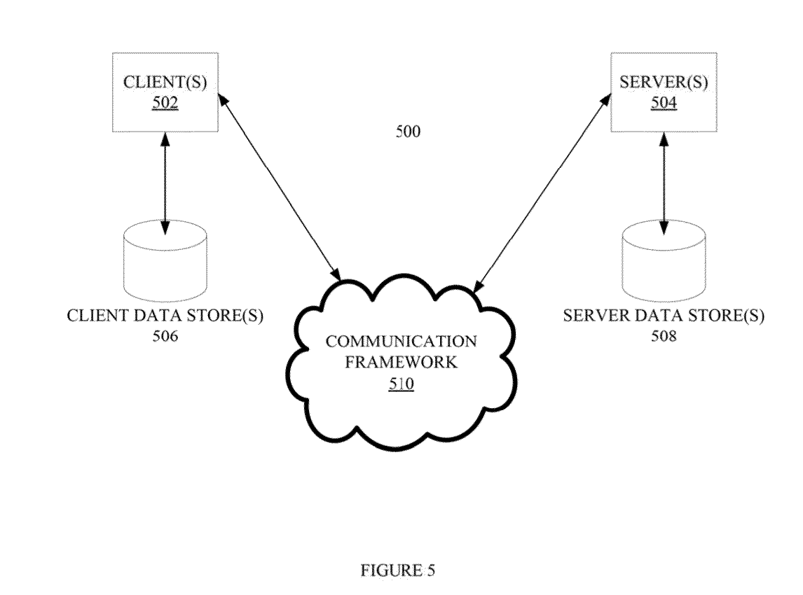

FIG. 5 illustrates another block diagram of a sample computing environment 500 with which embodiments may interact. The system 500 further illustrates a system that includes one or more clients 502. The client(s) 502 may be hardware and/or software (e.g., threads, processes, computing devices). The system 500 also includes one or more servers 504. The server(s) 504 may also be hardware and/or software (e.g., threads, processes, computing devices). One possible communication between a client 502 and a server 504 may be in the form of a data packet adapted to be transmitted between two or more computer processes. The system 500 includes a communication framework 510 that may be employed to facilitate communications between the client(s) 502 and the server(s) 504. The client(s) 502 are connected to one or more client data stores 506 that may be employed to store information local to the client(s) 502. Similarly, the server(s) 504 are connected to one or more server data stores 508 that may be employed to store information local to the server(s) 504.

Exemplary Use Cases

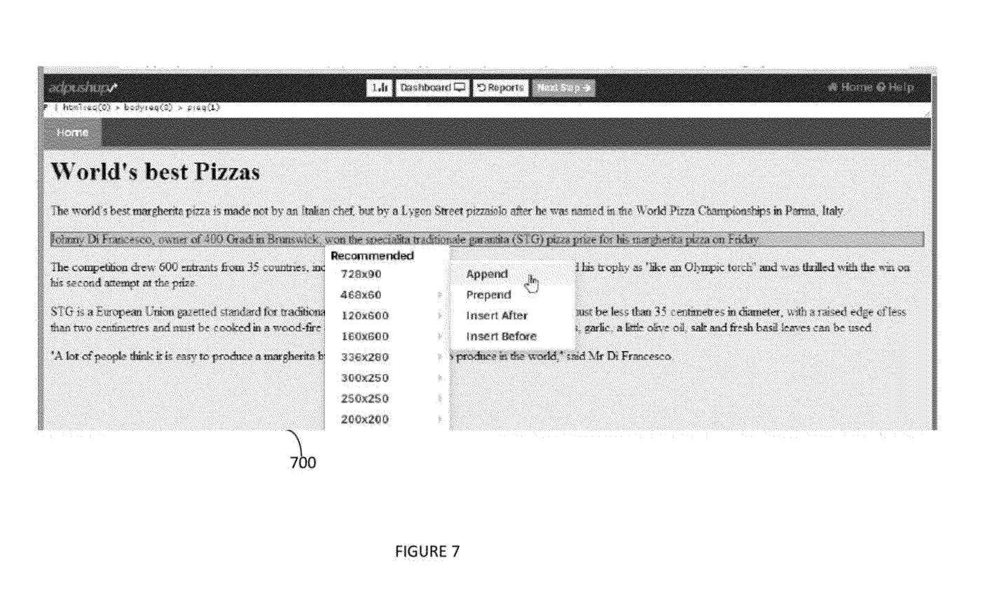

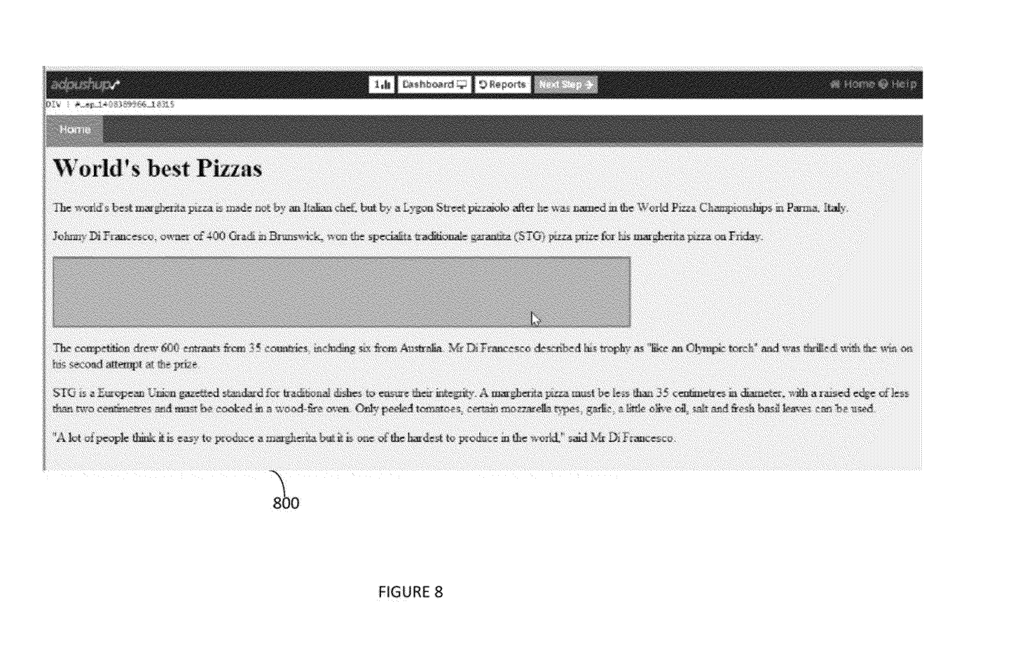

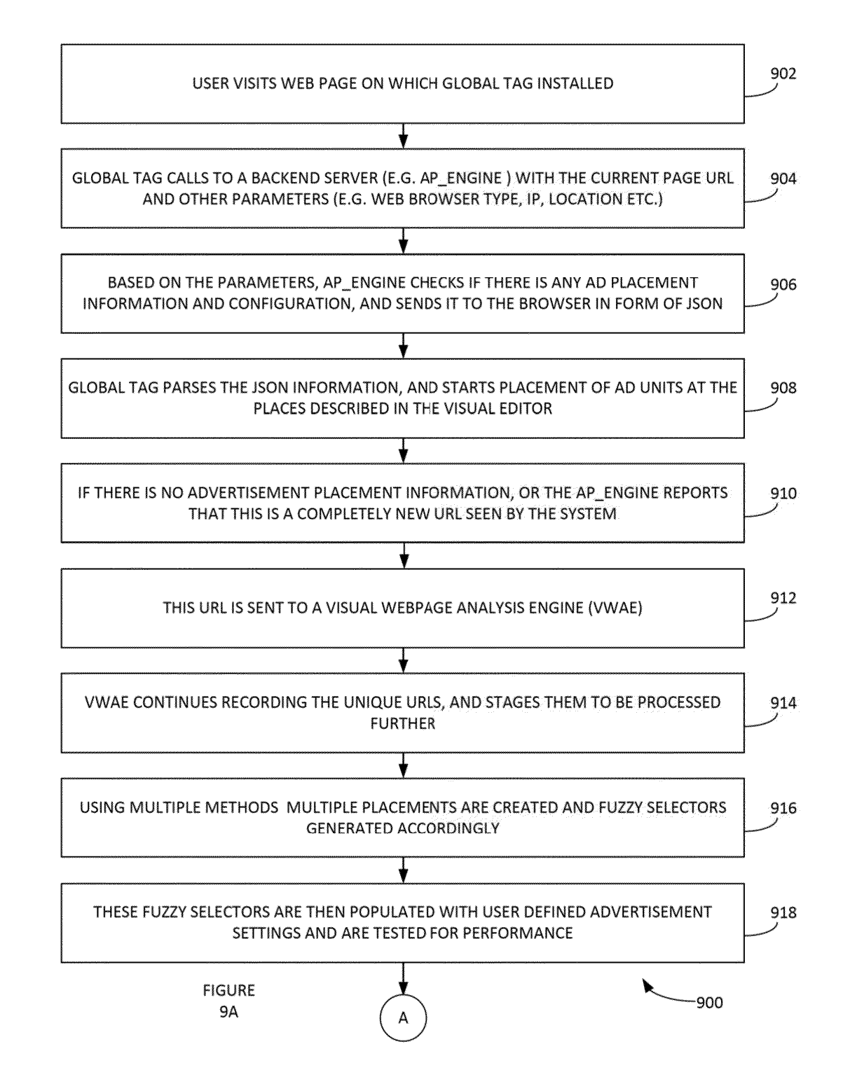

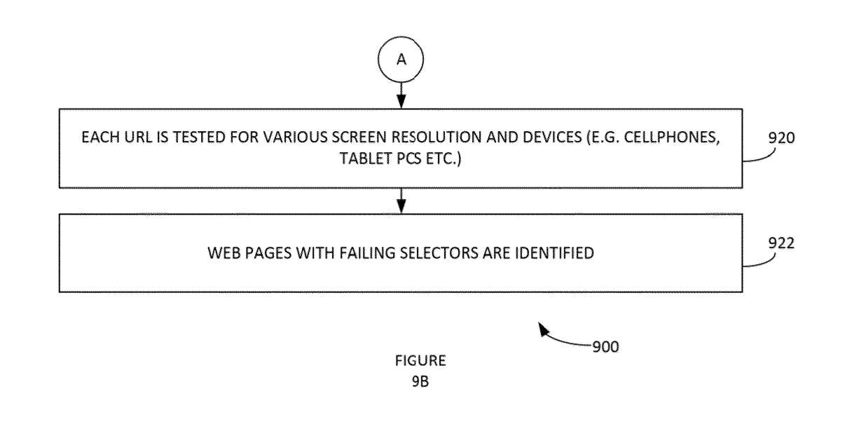

FIGS. 6-8 depicts various screen shots of use cases of an example embodiment. FIG. 6 depicts an example of a visual editor being used to select a web page element to generate a selector, according to some embodiments. As seen in the image above, the selector for the highlighted paragraph is: html:eq(0)>body:eq(0)>p:eq(1). In the visual editor view of the web page, after the element of interest (e.g. the element near the advertisement placement), one of the four operations can be implemented: append, prepend, insert before, insert after, as provided in FIG. 7. In one particular example, ‘insert after’ can be selected and an ‘adsize block’ placed inside the webpage as shown in FIG. 8.

As used herein, a postType (e.g. page, post) can be utilized. Exemplary postTypes are now provided, however, it should be noted that other WordPress postTypes are extant. WordPress can hold and display many different types of content. A single item of such content can be called a post, although post can also be a specific post type in some examples. Internally, the post types can be stored in the same location (e.g. in the wp_posts database table) but are differentiated by a column called post_type (e.g. see http://codex.wordpress.org/Post_Types). The following postTypes can be defaults, inter alia: Post (Post Type: ‘post’); Page (Post Type: ‘page’); Attachment (Post Type: ‘attachment’); Revision (Post Type: ‘revision’); Navigation menu (Post Type: ‘nav_menu_item’).

Automated Advertisement Placement Using Visual Analysis of Web-Pages.

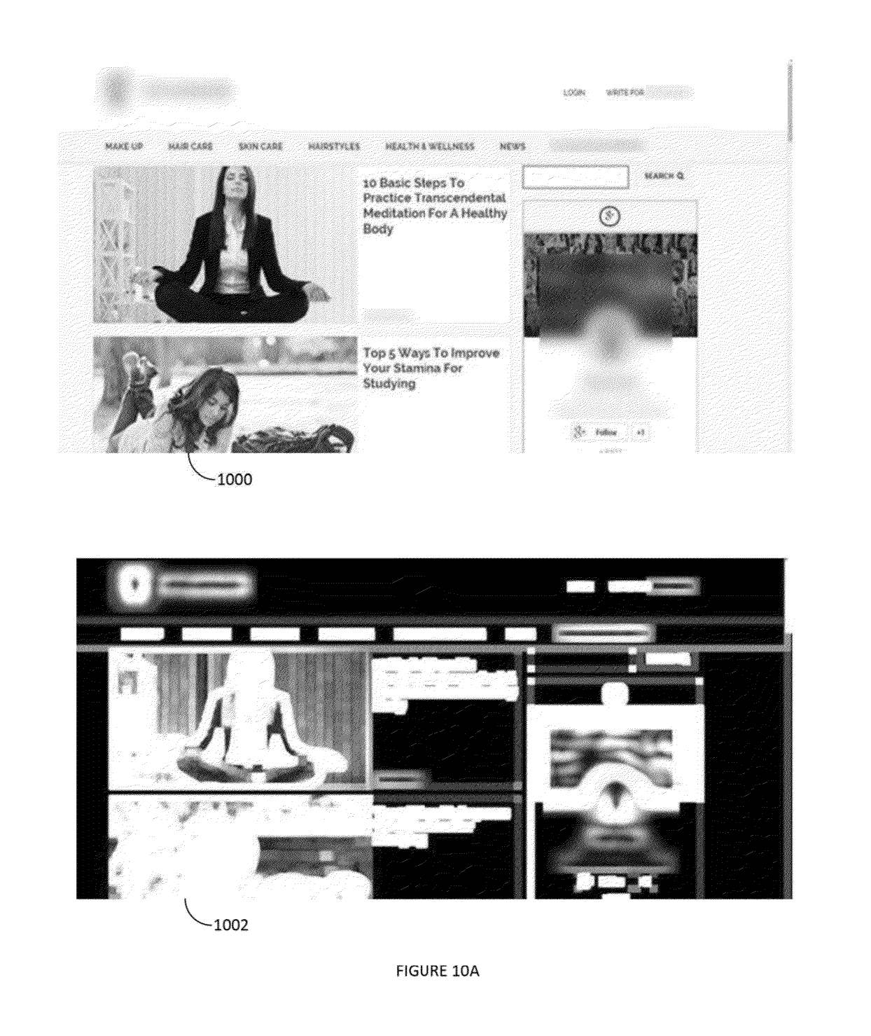

As noted, fuzzy selectors can be generated using a visual editor tool. As previously explained, these fuzzy selectors are then utilized to insert advertisements—and ultimately create advertisement placements. The Visual Editor is a manual way, where in the onus of creating the placements lies on the software user (a web publisher). It can be possible, the user is not experienced (and unaware of best practices), and creates very few or very poor advertisement placements. In this case, the advertisement revenue optimization might suffer as the options available for testing are very few or very poor. Accordingly, a method to automate the process of visual analysis of the page, and create automatic placements can be implemented. This automatic analysis can be done uniquely for each page, or can be done for one type of page in a group. Process 900 of FIG. 9 provides a method of implementing automatic advertisement placement using visual analysis of web pages, according to some embodiments. In step 902, a user visits web page on which global tag installed. In step 904, the global tag calls to a backend server (e.g. Ap_Engine 306) with the current page URL and other parameters (e.g. web browser type, IP, location etc.). In step 906, based on the parameters, Ap_Engine 306 checks if there is any advertisement placement information and configuration, and sends it to the browser in form of JSON. In step 908, the global tag parses the JSON, and starts placement of advertisement units at the places described in the visual editor. In step 910, if there is no advertisement placement information, or the Ap_Engine reports that this is a completely new URL seen by the system 300. In step 912, this URL is sent to a visual webpage analysis engine (VWAE). In step 914, VWAE continues recording the unique URLs, and stages them to be processed further. As a part of the processing, the URL is rendered in a web-browser (or browser-like environment). In step 916, using multiple methods (which includes, but is not limited to, image processing, collision detection, contiguous area detection, Web Page DOM analysis, etc.) multiple placements are created, and fuzzy selectors based on them are generated. Some examples of these methods are provided infra. In step 918, these fuzzy selectors are then populated with user defined advertisement settings and are tested for performance. In step 920, each URL is tested for various screen resolution and devices (e.g. cellphones, tablet PCs etc.). In step 922, using an approach (e.g. such that explained with respect to “CSS/XPATH Selector failure”), web pages are identified where the selectors are failing. Process 900 can be repeated to generate new placements of other advertisements on one or more web pages.

Contiguous Area Detection

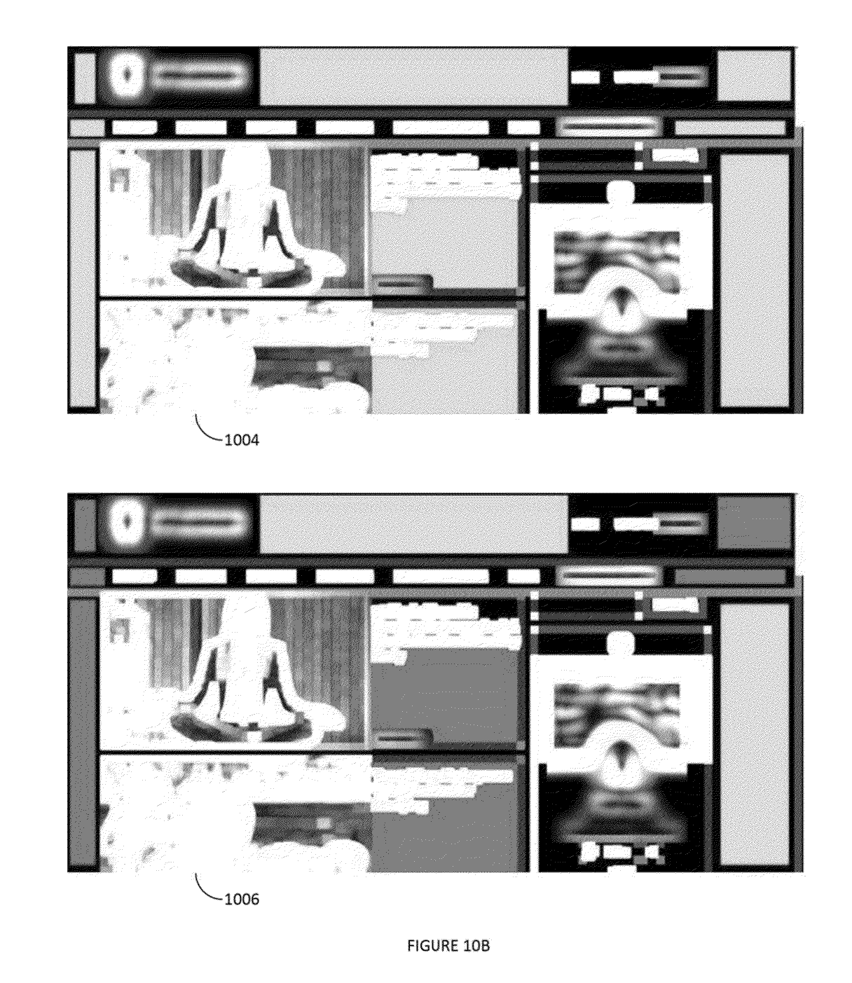

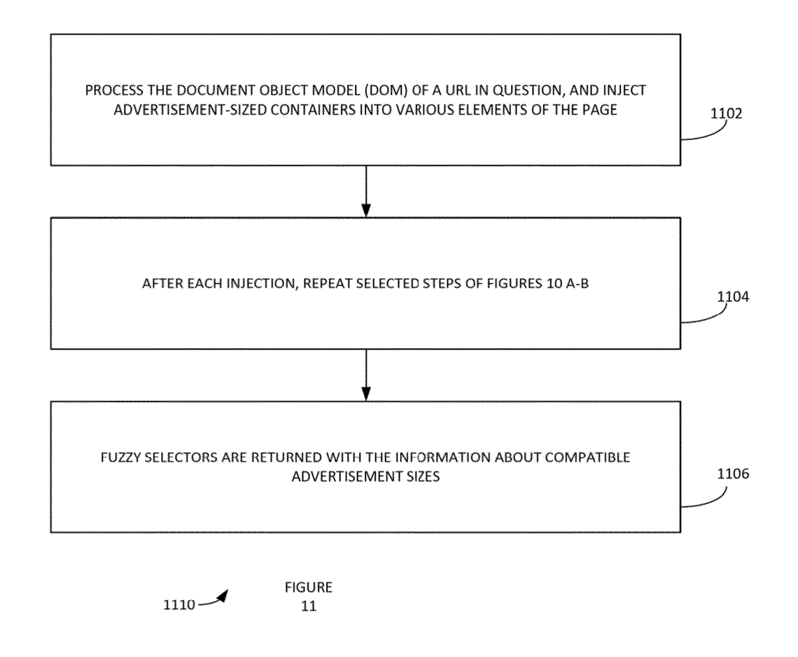

FIGS. 10 A-B depict examples of using contiguous area detection for automatic advertisement placement on a webpage, according to some embodiments. Contiguous blocks of similar colored areas on the webpage can be determined. These blocks are tried with advertisements, and then converted to placements. Image 1000 shows a website rendered into the system, and converted to an image for analysis. Image 1002 shows image processing being implemented to make the edges more prominent. Image 1004 shows the detection of contiguous areas. Continuous areas are in the webpage are shown in green. Image 1006 shows the rejection of some contiguous areas that are determined to be below a specified size threshold (shown in red). These shortlisted areas can be reverse mapped to web page elements (e.g. using element position tracking). Advertisement-like containers can be inserted inside these page elements. Multiple advertisement sizes can be tried. After every advertisement sized container insert, the web page can be re-rendered as an image, and analysis can be carried out to determine if the new advertisement insertion, inter alia: blocks any element; is blocked any element; collides with any element; drastically changes the web page flow (e.g. as compared to original page); leaves significant amount of white/empty spaces on sides/top/bottom; wraps properly with surrounding text; etc. For checking if a container blocks or is blocked by any element, we can create the element in a transparent color, and then sample the colors of the transparent box area. If the colors inside the transparent colors are more than a single color, it indicates the transparent color is blocking/or is getting blocked by an element—thus not suitable for proceeding further. These steps can be implemented on for all the identified blocks in the web page. Based on certain defined acceptance threshold for parameters listed in earlier steps, these blocks and advertisement sizes can be shortlisted further. The system can then create fuzzy selectors for the shortlisted blocks. If the system is unable to create reliable, repeatable selectors, then the selectors are further rejected. The accepted fuzzy selectors can then be returned with the information about compatible advertisement sizes.

FIG. 11 illustrates an example process 1100 of using Webpage DOM analysis, according to some embodiments. In step 1102 of process 1100, the Document Object Model (DOM) of the URL in question is processed. Advertisement-sized containers inject (e.g. append, prepend, insert before or insert after) into various elements of the page. These elements can be selected based on some thresholds like total element area, and selected element type (e.g. table, DIV, P, image, Object) etc. In step 1104, after each injection, selected steps of the process of FIGS. 10 A-B (e.g. step 6-10) of the previous method can be implemented. In step 1106, fuzzy selectors can be returned with the information about compatible advertisement sizes.

Additional Methods and Systems Related to Advertisement Blocking

A method for reclaiming advertisement-blocked impressions can be implemented. Usage of advertisement blocking software (e.g. browser extensions, application software, mobile applications) and/or hardware (e.g. routers, network devices) is on the rise. To address this concern, a method can be implemented to enable advertisement publishers to circumvent some advertisement blocking methods. The can include detecting the presence of advertisement blocking mechanisms. For users who have advertisement blocking software, the system can show advertisements which are deemed ‘acceptable’ (e.g. whitelisted) by the advertisement blocker and/or route the advertisements through the publisher's website itself.

A method of advertisement block detection can be implemented. For example, advertisement blockers can operate on some predefined filters. Accordingly, the advertisement blocker can be detected, inter alia, by the following: initiate network calls to a set of filtered URLs (if the call leads to repeated failures, this can indicate presence of advertisement block); try to load an external script having a filtered name (if the script did not execute, it can indicate the presence of advertisement block); try to load a page element with a filtered name/attribute (if the element is not visible/removed/or not created at all, it can indicate presence of advertisement block); etc. A user's web browser can then be tagged with cookie (or other tag), such that this process of advertisement block detection is not required to be carried out repeatedly. These tags can be utilize across different websites. Whitelisted advertisements can be utilized. For example, some advertisement blocking software (such as Adblock Plus™—Acceptable Advertisements) can maintain a list of whitelisted advertisement networks. Advertisements from these whitelisted networks can be loaded by an application in cases where an advertisement block presence has been detected. The advertisement can be routed through publisher's site. The advertisements can be rendered and/or called on the client-side by a scripting language like JavaScript. By implementing a server-side mechanism (e.g. a proxy server/proxy script/data transfer agents) on the publisher's own website/webserver, server-to-server communicate can be enabled between a publisher's website and an advertisement networks. The publisher's website can then return advertisements in real time and/or maintain a cache of advertisements by downloading it from the advertisement networks. The advertisement networks can provide an application programming interface(s) (APIs) for this transfer.

If presence of a user (e.g. a user's web browser) with advertisement block is detected, instead of executing the standard advertiser snippet (which can be eventually blocked by the advertisement block), a call to the publisher's own server can be made. This call can obtain an advertisement creative (e.g. advertisement text, advertisement size, advertisement image, advertisement attributes like landing URL, etc.) from the cache and/or in real time (e.g. via a server to server call). Since this advertisement creative is returned from the publisher website itself, the advertisement block software cannot block these (unless the publisher's website URL is filtered altogether—in which case the user won't be able to visit the site in the first place). The object attributes can be constantly updated and randomized such that there are not yet applicable filters for blocking them.

In some embodiments, a digital wallet can be created for use by end-users (e.g. website visitors). The user can purchase credit for the digital wallet with any amount and/or currency. The credit process can use various online banking or credit/debit cards. The users who have credited their digital wallets, to receive alert whenever the website provides an option for ‘advertisement rejection’. For example, when the visitor visits a website that includes an advertisement (e.g. an advertisement implemented by the various processes and/or systems described herein) installed, the user can be alerted about the advertisement rejection option. If the user chooses to reject the advertisement, the user can be presented with various advertisement rejection and/or rejection duration options. Accordingly, the user can choose to pay for the advertisement rejection option per the stated price and duration. The digital wallet can be accessed for the payment.

The advertisement rejection process can utilize, inter alia, the following example pricing factors: user's demographics (e.g. country, age group, gender etc.); the performance of the vertical the website is operating in; an average CTR (click through rate) of the website; an average RPM (revenue per thousand impressions); etc. In some examples, the advertisement rejection price can be calculated that on a probabilistic basis utilizing information about what revenue this user would have generated by advertisements for the website for a certain period (e.g. one day, one week, one month, etc.). This revenue can be presented to the user directly, and if the user finds it fair, the user can opt into the advertisement rejection process for the desired time period. The advertisement system provided supra can handle the payments for the user. Accordingly, the user can select the advertisement rejection service once and the advertisement rejection service can be implemented across all advertisements provided by the advertisement system.

### CONCLUSION

Although the present embodiments have been described with reference to specific example embodiments, various modifications and changes can be made to these embodiments without departing from the broader spirit and scope of the various embodiments. For example, the various devices, modules, etc. described herein can be enabled and operated using hardware circuitry, firmware, software or any combination of hardware, firmware, and software (e.g., embodied in a machine-readable medium).

In addition, it can be appreciated that the various operations, processes, and methods disclosed herein can be embodied in a machine-readable medium and/or a machine accessible medium compatible with a data processing system (e.g., a computer system), and can be performed in any order (e.g., including using means for achieving the various operations). Accordingly, the specification and drawings are to be regarded in an illustrative rather than a restrictive sense. In some embodiments, the machine-readable medium can be a non-transitory form of machine-readable medium.

An example of environment capturing is now provided. An additional benefit of doing the visual analysis of the pages would be the fact that we can also record the ad environment in which it's tested. For example, if the area where the ad is tested had black background and white text, we can record this fact, and utilize them when we create ads for testing. In this specific case, the ad which will be created can be with black background and white text (blending in) or white background and black text (contrast).

A method to increase the ad performance also revolves around a system to passively observe the user behavior and personalize the page accordingly, and setup the page layout, including ad placements. We can monitor the areas of the page user is interested in by monitoring his mouse movement, webpage scrolling pattern, time exposed for every dom element etc. In parallel, we can also record user attributes such as his IP address, exact or approximated geolocation, browser, time of the day, operating system, device type etc. to tag the observed behavior. Based on the behavior observation, we can make specific changes automatically that would make the web page layout most conducive for the user—and ultimately, reach our goal of increasing the ad performance. In this system, we can also measure the user experience metrics (like time on site, bounce rate, pageview per user session etc.) and add these as parameters in the system. Further, based on the website owner's preferences, we can balance the website ad monetization efforts based on the user experience too.

For monitoring the user behavior with respect to ads, we have created a clicktracking technology which utilizes specific inventions to track user clicks and taps (on touch devices) on ad locations. Tracking clicks or taps on ad location is particularly difficult, as the ads are mostly delivered in 3^{rd} party iframes. 3^{rd} party iframes can't be tampered with, or observed in the current context (referred further as the parent or the host document), since these iframes follow a browser security model called Same Origin Policy (https://en.wikipedia.org/wiki/Same-origin_policy).

Our clicktracking technology combines many heuristics to determine if a click has happened on a ad frame or not. One such method is outlined below:
1) User opens a webpage.
2) User scrolls to an advertisement. Advertisement is wrapped in our container. The container can indicate that the advertisement is on screen now.
3) Once we detect the advertisement is on screen, we record this fact. Further we monitor the host document's “focus” property. This “focus” properly is a Javscript property.
4) if the focus is lost from the host document, it can be because of multiple reasons, one of them being the ad click (as ad click mostly takes the user from the current page to the advertiser's page).
5) If the focus is lost because of the ad click, the ad iframe element also gets an “active” status, not in as javascript property (because of the same origin policy), but as a CSS property.
6) If along with the host document losing focus, the iframe container gets the active property, it can be said with some reliability that the ad is clicked. But this behavior can also occurs when a user accidently taps the ad area when scrolling etc. Browsers don't trigger the ad click in such scenarios.
7) In order to check with certainty that the click has happened indeed on the ad, we try to check if the user is redirected to the new advertiser webpage or not. For this, we monitor the browser “unload” event.
8) If these things happen in succession—document focus lost, iframe focus gain, and unload event—it can be said with a high degree of certainty that the ad click has happened.

The following system can be continually improved focusing on the internal browser behavior. This clicktracking approach gives multiple advantages such as:
1) Not being dependent on the advertiser for click performance data
2) Having performance data as first-party data—on which we can apply multiple user behaviour and attributes as tags (IP address, exact or approximated geolocation, browser, time of the day, operating system, device type etc.)
3) Works across any ad network.
4) Ad performance is immediate, and not adjusted by the advertiser.
5) Etc.

What is claimed as new and desired to be protected by Letters Patent of the United States is:

1. A computerized-method implemented by at least one server comprising:
providing a web-page document visual editor;
providing a web-page and website analysis engine, which does automated webpage and website analysis;
placing, with the web-page document visual editor and the automatic analysis engine, an advertisement selector in a web page document;
identifying one or more advertisement attributes of the web-page document;
setting a location of an advertisement block in a display of the web-page document with respect to an element of the web page document;
generating a global tag, wherein the global tag comprises a system instrumentation JavaScript code, and wherein the global tag retrieves a list of relevant selectors; and
inserting the global tag into the web-page document.

2. The computerized-method of claim 1 further comprising:
detecting that a user-computing device downloads the web-page document.

3. The computerized-method of claim 2, wherein the global tag calls to a backend application with a set of parameters, wherein the set of parameters comprises a current page uniform resource locator (URL).

4. The computerized-method of claim 3, wherein the set of parameters further comprises a web browser identity of user-computing device, an Internet protocol (IP) address of the user-computing device, and a location of the user-computing device.

5. The computerized-method of claim 4 further comprising:
based on the set of parameters, generating, with the backend application, an advertisement placement configuration; and
communicating the advertisement placement configuration to a web browser of the user-computing device.

6. The computerized-method of claim 5, wherein the advertisement placement configuration is communicated to the web browser in a JavaScript Object Notation (JSON) format, and wherein the advertisement placement configuration comprises an advertisement network identity and an advertisement size value.

7. The computerized-method of claim 6 further comprising:
populating an advertisement container a of the web-page document with the advertisement placement configuration; and
initializing the advertisement code of the web-page document.

8. The computerized-method of claim 7, wherein the global tag is configured to collects a set of background feedback and analytics information and communicate the set of background feedback and analytics information to the backend application.

9. The computerized-method of claim 8, wherein the advertisement container comprises a hyper-text markup language (HTML) tag inside which an advertisement code is triggered, and wherein a triggered advertisement code creates an advertisement unit.

10. The computerized-method of claim 9, wherein the one or more advertisement attributes of the web-page documents comprises a web-page element of interest and an advertisement size.

11. The computerized-method of claim 10, wherein the global tag collects background information about the web page.

12. The computerized-method of claim 11, wherein the global tag collects a time a user spends on each DOM element of the web page.

13. A computerized system implemented by at least one server comprising:
a processor configured to execute instructions;
a memory containing instructions when executed on the processor, causes the processor to perform operations that:
provide a web-page document visual editor;
provide a web-page and website analysis engine, which does automated webpage and website analysis;
place, with the web-page document visual editor, an advertisement selector in a web page document;
identify one or more advertisement attributes of the web-page document;
set a location of an advertisement block in a display of the web-page document with respect to an element of the web page document;
generate a global tag, wherein the global tag comprises the one or more advertisement attributes and the location of the advertisement block in the display of the web-page document with respect to the element of the web page document; and
insert the global tag into the web-page document.
